(19) United States
(12) Patent Application Publication
(10) Pub. No.: US 2026/0310816 A1
(43) Pub. Date: Oct. 8, 2026

(54) AUTOMATED DATA ACCESS POLICY ENFORCEMENT

(71) Applicant: Coinbase, Inc., Oakland, CA (US)

(72) Inventors: Abhishek Somani, Hyderabad (IN); Shuang Liu, Bothell, WA (US); Nikhil Chennu, Hyderabad (IN); Gaurav Sagar, Bellevue, WA (US); Guoqing Xu, Bellevue, WA (US)

(21) Appl. No.: 19/232,679

(22) Filed: Jun. 9, 2025

(30) Foreign Application Priority Data
Apr. 3, 2025 (IN) 202511032930

(51) Int. Cl. G06F 21/62; G06F 16/332

(52) U.S. Cl. CPC G06F 21/6227; G06F 16/332

(57) ABSTRACT

Methods, systems, and devices for data management are described. The described techniques may enable automated data access policy enforcement. For example, a method may include generating a schema associated with accessing a data table in accordance with an access policy, the data table comprising respective timestamps associated with data records of the data table, generating a data table view of the data table that is configured to access a subset of the data records of the data table that satisfies the access policy based on the respective timestamps of the data records of the data table, wherein the data table view is accessed using the schema, identifying a client application comprising one or more queries targeted to the data table, and rewriting the one or more queries to target the schema of the data table view instead of the data table such that the client application satisfies the access policy.

### CROSS REFERENCE

The present application claims priority to Indian Patent Application No. 202511032930, by Somani et al., entitled “AUTOMATED DATA ACCESS POLICY ENFORCEMENT,” filed Apr. 3, 2025, which is assigned to the assignee hereof and expressly incorporated by reference herein.

### FIELD OF TECHNOLOGY

The present disclosure relates generally to data management, including techniques for automated data access policy enforcement.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports automated data access policy enforcement in accordance with aspects of the present disclosure.

FIG. 2 shows an example of a computing environment that supports automated data access policy enforcement in accordance with aspects of the present disclosure.

FIG. 3 shows an example of a computing environment that supports automated data access policy enforcement in accordance with aspects of the present disclosure.

FIG. 4 shows an example of a process flow that supports automated data access policy enforcement in accordance with aspects of the present disclosure.

FIG. 5 shows a block diagram of an apparatus that supports automated data access policy enforcement in accordance with aspects of the present disclosure.

FIG. 6 shows a block diagram of a client application that supports automated data access policy enforcement in accordance with aspects of the present disclosure.

FIG. 7 shows a diagram of a system including a device that supports automated data access policy enforcement in accordance with aspects of the present disclosure.

FIGS. 8 and 9 show flowcharts illustrating methods that support automated data access policy enforcement in accordance with aspects of the present disclosure.

### DETAILED DESCRIPTION

In some examples, a data retention policy may define one or more criteria for accessing data that may ensure secure data access and prevent unauthorized access to the data. For example, the criteria may define a duration during which the data may be accessed, which may support regulatory compliance and maintain customer trust. In some examples, the data may be factual datasets that may contain sensitive customer information. Accordingly, policies for accessing the data may include relatively strict regulatory requirements and data governance policies. Such retention policies may be relatively difficult to impose at a large scale. For example, such systems may lack a standardized mechanism to enforce retention policies based on specific data-use cases and time-based filters, which may lead to over-retention or unrestricted access to sensitive data. Such systems may also lack robust mechanisms to track data usage in real-time, identify violations, and enforce compliance. For example, manual audits and reactive measures may result in inefficiencies and delayed resolution of non-compliance issues. Implementing retention policies across diverse datasets and architectures may involve significant operational effort, and manual processes may be prone to errors and inefficiencies. Additionally, fact datasets are often joined with non-fact datasets in queries, which may impacting downstream applications and workflows.

Accordingly, techniques described herein may enable an automated framework for enforcing offline data retention policies through the creation of programmatic data views. For example, the described techniques may include identification of fact tables and creation of sidecar schemas, which may enable access to filtered data views of the fact tables. The filtered data views may be filtered to include a subset of data of the fact tables that satisfies access policies. The described techniques may further include rewriting queries to request access to the filtered data views (e.g., rather than the source fact table). In some examples, the automated framework may monitor for policy violations. By identifying datasets, managing access based on data-use, and continuously monitoring for violations, the automated framework may enable secure data handling and retention governance. For example, the described techniques may enable users (e.g., via online systems or offline systems) to access data with relatively increased security and efficiency.

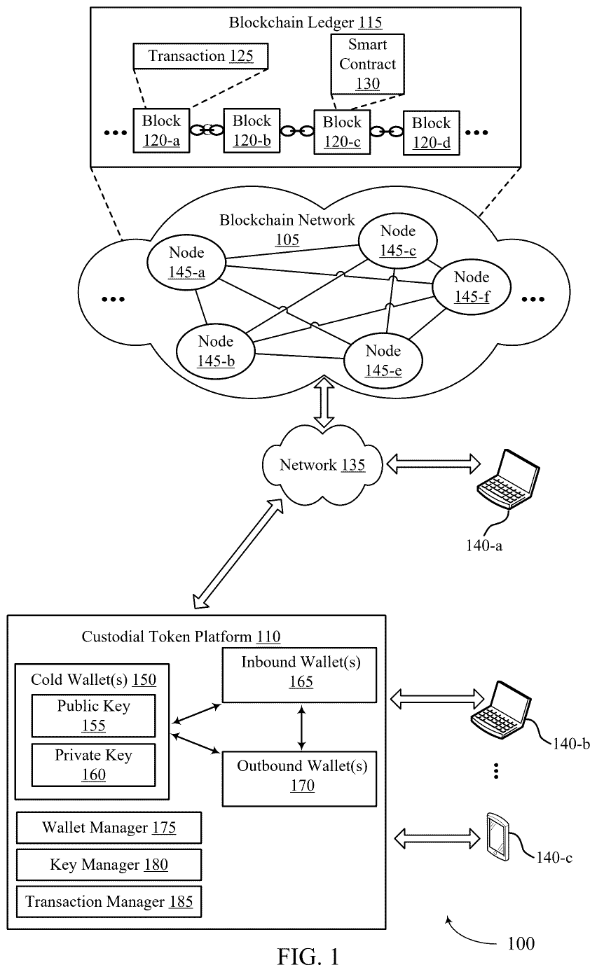

FIG. 1 illustrates an example of a computing environment 100 that supports automated data access policy enforcement in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some examples of the computing environment 100, a computing device 140 may perform data retention (e.g., enforcement of data access policies) via an automated framework for enforcing offline data retention policies. For example, the automated framework may enforce data retention policies by creating data views of data tables (e.g., fact tables) that enable access to a subset of data records in the fact table. The automated framework may generate sidecar schemas that may enable access to the data views, which may allow a user to access a subset of the data records without accessing the full data table. In some examples, the automated framework may perform monitoring for policy violations (e.g., automated monitoring), which may enable the automated framework to revoke access to the data tables in response to identifying violation of access policies.

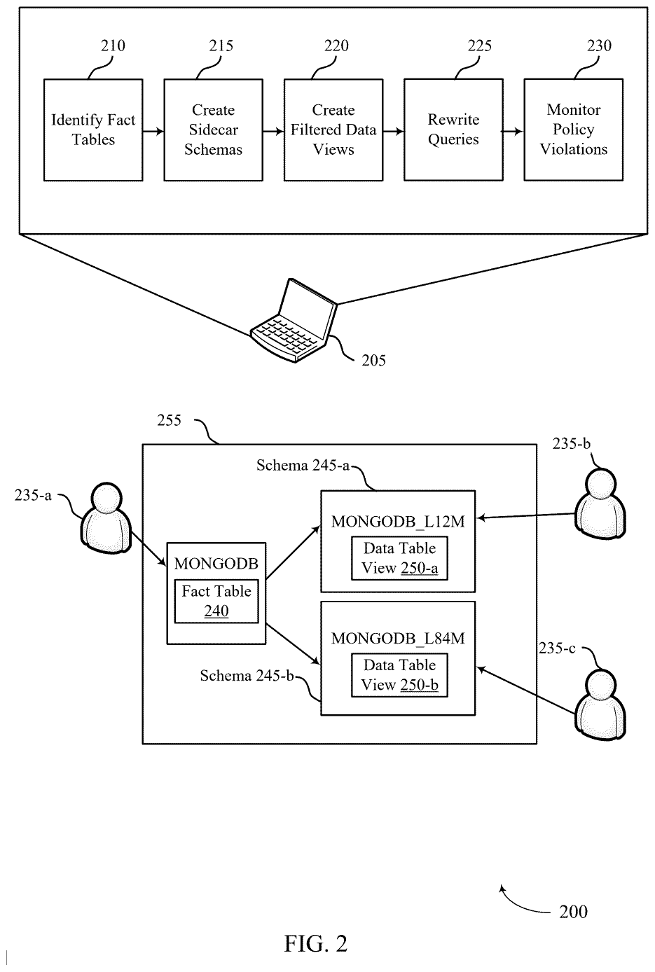

FIG. 2 shows an example of a computing environment 200 that supports automated data access policy enforcement in accordance with aspects of the present disclosure. The computing environment 200 may implement or may be implemented by aspects of the computing environment 100. For example, the computing environment 200 may include a computing device 205, which may be an example of the corresponding entity as described with respect to FIG. 1.

In some examples of computing environments 200, a data retention policy may define one or more criteria for accessing data that may ensure secure data access and prevent unauthorized access to the data. Such techniques may be referred to herein as data retention. For example, the criteria may define a duration during which the data may be accessed, which may support regulatory compliance and maintain customer trust. In some examples, the data may be factual datasets that may contain sensitive customer information. Policies for accessing the data may include relatively strict regulatory requirements and data governance policies. Such retention policies may be relatively difficult to impose at a large scale, and may lack robust mechanisms to track data usage in real-time, identify violations, and enforce compliance. Additionally, fact datasets are often joined with non-fact datasets in queries, which may impacting downstream applications and workflows.

Techniques described herein may enable an automated framework for enforcing offline data retention policies through the creation of programmatic data views by a computing device 205. For example, the described techniques may enable systems (e.g., online systems, offline systems) to access data with relatively increased security and efficiency.

As described herein, online systems may refer to product applications or services that provide real-time, application programming interface (API)-driven data access, such as services that manage user sessions, product inventory, or payment processing. Such online systems may interact with operational data stores to support business operations. Such online systems may be designed to handle transactional workloads and power customer-facing features, which may enable low-latency responses and high availability. Offline systems may refer to data-processing ecosystems designed for large-scale data transformations, analytics, and machine learning workflows, such as Airflow pipelines for Extract, Transform, Load (ETL) operations, machine learning (ML) feature generation pipelines using tools, and batch data processing for business intelligence and reporting. Such offline systems may use data stored at data warehouses or distributed data platforms. Offline systems may be associated with relatively higher scalability and computational power then online data systems, which may be associated with relatively shorter response times.

For example, at 210, the computing device 205 may identify fact datasets (e.g., a fact table 240) within a database 255 that are in scope for one or more retention policies. The identified fact tables 240 may be used according to one or more data use tags, such as for marketing, analytics, or personalization. The computing device 205 may use an automated discovery mechanism to identify fact tables 240 that are in scope for retention enforcement, which may result in comprehensive and consistent coverage across multiple datasets. Such techniques may be relatively more efficient and comprehensive than static configurations or ad hoc manual tagging to determine which datasets may satisfy retention policies (e.g., access policies).

At 215, the computing device 205 may generate duplicate (e.g., sidecar) schemas 245 for the fact tables 240. As described herein, a sidecar schema 245 may be supplementary schemas created alongside primary schemas (e.g., primary schemas of the fact tables 240) to enforce data retention policies programmatically. Sidecar schemas 245 may contain filtered views of the original data that may be tailored to meet specific retention requirements without altering the base datasets. Such sidecar schemas 245 may be appended with predefined suffixes (e.g., __L12M for 1-year retention and __L84M for 7-year retention) to store filtered views of the original fact datasets, allowing seamless enforcement of retention policies without altering the original datasets. As an illustrative example, using a fact table 240 associated with a name MONGODB, the computing device 205 may generate a schema 245-a with a name MONGODB_L12M for 1-year retention and a schema 245-b with a name MONGODB_L84M for 7-year retention.

Each duplicate schema 245 may be associated with data from the respective fact table from a predefined range of time (e.g., with timestamps within a time window, such as one year or seven years). Such schemas 245 may contain data that adheres to predefined retention policies, ensuring compliance while preserving the integrity of the base datasets. Accordingly, the sidecar schemas 245 may be reduce engineering effort and workflow reduction as compared to retention policies that are enforced using hard deletions, data masking, or custom scripts applied manually. The computing device 205 can accommodate multiple retention timeframe, whether shorter (e.g., 6 months) or longer (e.g., 10 years), by dynamically creating appropriate schemas 245. As new datasets or fact tables are onboarded, the system may automatically include the new datasets in the sidecar schema generation process.

At 220, the computing device 205 may programmatically create time-filtered views (e.g., data table views 250) within the sidecar schemas 245, which may enable compliance with retention policies while maintaining data integrity for business use cases. For example, access permissions to such time-filtered views may be determined by a data-use category indicated in a request to access the fact table 240 (e.g., analytics, marketing, personalization, regulatory compliance, service fulfillment, product fulfillment etc.) and a role of a user or service account 235 requesting access. As an illustrative example, a service account 235-a may access the full fact table 240 for regulatory compliance, account protection, service fulfillment, and product fulfillment. A user 235-b may access a data table view 250-a including data records associated with timestamps from a time window of one year via the schema 245-a (e.g., with a 1-year retention) for marketing, personalization, research, and development. A user 235-c may access a data table view 250-b including data records associated with timestamps from a time window of seven years via the schema 245-b (e.g., with a 7-year retention) for analytics. This granular approach may enable individuals to access the data for specific tasks, service accounts (e.g., APIs or applications) to access the datasets relevant to operational needs, and data-use categories to define the scope and depth of access, which may reduce unnecessary exposure of sensitive information.

At 225, the computing device 205 may automate the process of rewriting queries to request access to these filtered views instead of base datasets, which may enable access that is restricted to the retention windows without disrupting existing workflows. For example, the computing device 205 may rewires queries to point to retention-compliant filtered views, which may reduce a need for manual intervention. Such techniques may enable policy enforcement at the query level rather than the data level, which may preserve data integrity and minimize disruptions as compared to some other solutions (e.g., solutions which may include manual modifications to queries or rely on downstream applications to enforce retention policies, which may be prone to error and inconsistencies).

At 230, the computing device may continuously monitor data usage and query patterns to detect policy violations. In some examples, the computing device 205 may provide real-time alerts and audit trails that may enable compliance and relatively faster remediation of non-compliance. For example, the computing device 205 may perform real-time monitoring of data access and query patterns to proactively detect violations. Such techniques may involve relatively less delay and penalties than periodic audits and after-the-fact corrections to identify compliance violations.

For example, the computing device 205 may continuously monitor how data is being accessed and who is accessing the data. The computing device 205 may track usage patterns, flag policy violations, and generate alerts when misuse or non-compliance is detected. Such ongoing oversight may enable adherence to retention policies and protection against unauthorized access.

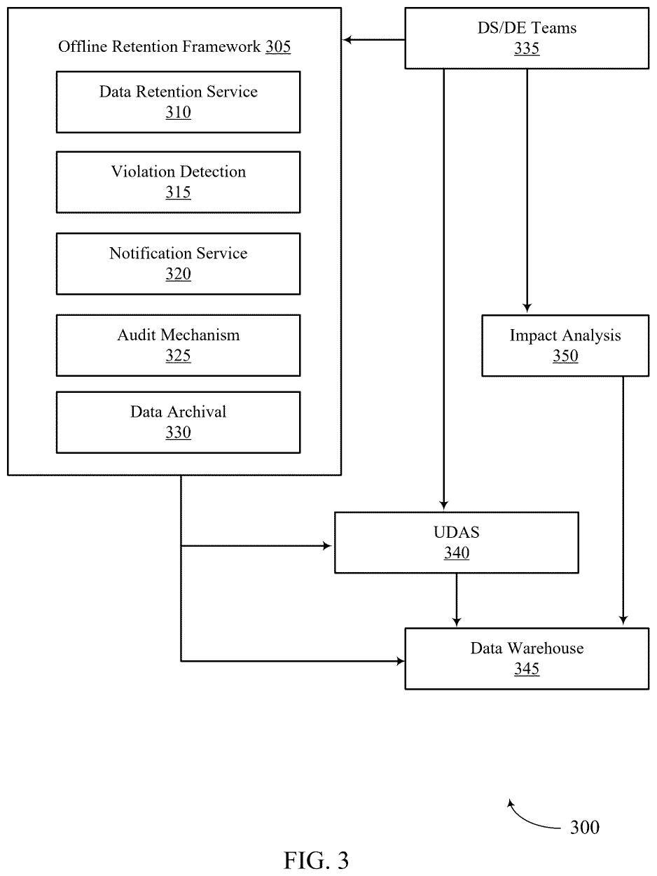

In some examples, one or more policies may be updated or new data-use policies may be introduced. In such examples, administrators of the database 255 may update the retention configurations to reflect the new policy (e.g., 3-year or 5-year retention). The system may automatically generate the corresponding filtered views and schemas (e.g., __L36M or __L60M schemas) across one or more fact tables in scope of the new policy. The computing device 205 may apply granular access rules to these new schemas 245 based on the updated data-use policies via a Universal Data Access System (UDAS). Accordingly, new data-use categories or regulatory requirements may be integrated into the system by updating configurations without altering the underlying architecture. In some examples, identification of fact tables 240 and creation of filtered data table views 250 may be performed by a data retention service, as described with reference to FIG. 3.

Such techniques may automate the enforcement of data retention policies, which may increase compliance with regulatory requirements without manual intervention. For example, the described techniques may provide real-time tracking, monitoring, and auditing capabilities, which may reduce the risk of violations and associated penalties. Additionally, the described techniques may leverage automated processes such as identifying fact datasets, creating filtered views, and generating sidecar schemas, which may enable scaling across diverse data architectures while reducing manual effort to manage retention policies. The described techniques reduce reliance on manual audits which may be relatively error-prone, saving time and operational costs. For example, automated query rewiring based on business data-use may increase business continuity without significant disruption to existing workflows, which may increase an operational efficiency associated with data retention.

The described techniques may increase data security and governance by restricting access to sensitive customer data based on time-based retention policies strengthens data governance and reduces unnecessary data exposure, building customer trust and safeguarding against data misuse. Additionally, the use of filtered views may preserve a join logic and data dependencies for downstream business workflows, which may prevent a compromise of operational effectiveness or data quality. Continuous monitoring of data usage and policy compliance may provide actionable insights and real-time alerts for violations, which may allowing proactive mitigation of risks and faster resolution of non-compliance issues.

FIG. 3 shows a computing environment 300 that supports automated data access policy enforcement in accordance with aspects of the present disclosure. The computing environment 300 may implement or may be implemented by aspects of the computing environment 100 or the computing environment 300. For example, the computing environment 300 may be implemented by a computing device 140, which may be an example of the corresponding entity as described with respect to FIG. 1

In some examples, as described with reference to FIG. 2, an offline retention framework 305 may enable automated access policy enforcement. For example, the offline retention framework 305 may include one or more entities or services that may generate filtered data views of data tables and schemas via which users or services may access the filtered data views. One or more entities of the offline retention framework 305 may additionally perform monitoring for violation of policies, which may enable the offline retention framework 305 to revoke access to the filtered data table views upon identification of a policy violation.

In some examples, a data retention service 310 of the offline retention framework 305 may perform identification of fact tables form a data warehouse 345, creation of filtered data views including a subset of data records of the fact tables, and creation of schemas via which a user may access the filtered data views. The data retention service 310 may accordingly enable teams and services (e.g., users) to access data in a controlled manner based on their specified data-use by providing inputs to a UDAS 340. The data retention service 310 may maintain metadata for the fact tables, including the timestamp column or expression used to create views, and may allow teams to refresh views on-demand and/or periodically. For example, the data retention service 310 may receive a request from a user to refresh a data table view, and may create an updated data table view in response to the request. The data retention service 310 may expose retention policies to other systems, supports Datahub by enabling teams to mark tables as non-fact, and may serve as an audit trail for any updates made to fact tables during audits.

In some examples, the UDAS 340 may manage access for individuals, service accounts, and system users. The UDAS 340 may control which users or services are enabled to access specific fact tables and data table views, which may enable data to be accessed appropriately. When requesting access to fact tables, users may specify a data use for the requested data, and the UDAS 340 may granted access based on the data use. For example, the UDAS 340 may identify an access permission associated with the data use, and may grant access according to the access permission. The UDAS 340 may function as an audit trail, which may enable privacy and auditing teams (e.g., an audit mechanism 325) to review data access requests and identify users who may have requested more access than an amount of access enabled for the indicated data use operations.

In some examples, a violation detection workflow 315 may perform policy violation monitoring. For example, the violation detection workflow 315 may conduct reactive analysis on queries from individuals or teams executed across different data warehouses 345 to detect retention violations (e.g., violations of access policies). The violation detection workflow 315 may provide detailed granularity, aggregating violations by table, schema, and data access governance (DAG). The violation detection workflow 315 may track coverage metrics in real-time, which may facilitate business reporting and transparency. By identifying and reporting violations, the violation detection workflow 315 may maintain compliance with access policies across an offline ecosystem managed by the offline retention framework 305. The violation detection workflow 315 may perform the policy violation monitoring periodically (e.g., every hour).

In some examples, an impact analysis component 350 may analyze queries and tasks such as those created by Data Science (DS) and Data Engineering (DE) teams 335. The impact analysis component 350 may enforce an addition of retention data use tags (e.g., a tag indicating a purpose of a query) and show a potential impact of these tags on downstream data lineage. For example, the impact analysis component 350 may cause display of a prompt for a user to input a data use tag, and may display the potential impact of the tag in response to receiving the data use tag from the user. The impact analysis component 350 may prevent non-compliant code (e.g., code that does not meet one or more requirements of the access policy) from being pushed to production. The impact analysis component 350 may promote standardization in query writing and data governance awareness among teams.

A notification service 320 may assist a privacy team in managing cross-functional requests with other teams by providing guiding for standards, addressing violations, and escalating issues. The notification service 320 may support multiple communication channels, which may provide the privacy team with visibility into enforcement activities. The notification service 320 may accordingly reduce manual interventions (e.g., from a Data Platform team).

In some examples, a data archival component 330 may archive older data from data assets for purposes that may use relatively less data than what is currently stored. For example, in cases where a table has been used for marketing over a long period (e.g., multiple years), the data archival component 330 may retain a most recent year of data and may store older data in a more cost-effective manner, which may reduce storage costs and computational expenses.

An audit mechanism 325 may review access to a particular table to maintain compliance with data use policies. The audit mechanism 325 perform on-demand or periodic sampling of fact tables to facilitate easier and more efficient audits. The audit mechanism 325 may confirm that data access is compliant with retention policies, which may provide an additional layer of oversight and accountability.

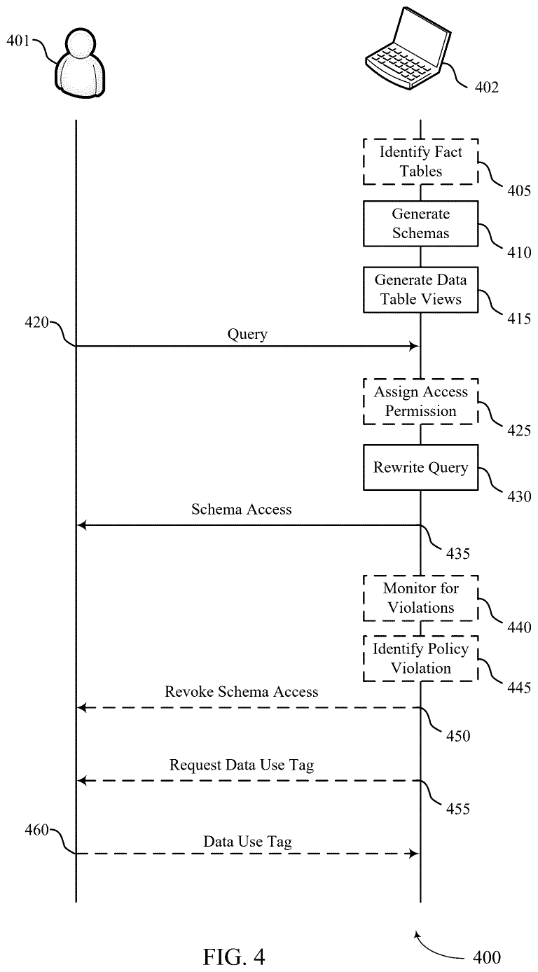

FIG. 4 shows a process flow 400 that supports automated data access policy enforcement in accordance with aspects of the present disclosure. The process flow 400 may implement or may be implemented by aspects of the computing environment 100, the computing environment 200, or computing environment 300. For example, the process flow 400 may be implemented by a computing device 402, which may be an example of the corresponding entity as described with respect to FIG. 1.

In the following description of the process flow 400, the operations between the user 401 and the computing device 402 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

At 405, the computing device 402 may identify a plurality of data tables from a database. The plurality of data tables may be one or more fact tables (e.g., tables comprising factual data). In some examples, data records of a data table may be associated with respective timestamps. For example, the respective timestamps may correspond to a date at which the associated data record was generated or collected.

At 410, the computing device 402 may generate one or more schemas associated with a first data table of the plurality of data tables. For example, the computing device 402 may generate a first schema associated with a first access policy, a second schema associated with a second access policy, and so on. In some examples, the computing device 402 may generate a schema name for each schema based on a table name of the data table and an indication of a time window associated with a respective access policy (e.g., a schema name with a suffix associated with the time window appended to the name of the data table).

At 415, the computing device 402 may generate one or more data table views of the data table (e.g., data table views that are accessed via a respective schema). Each data table view may be configured to access a subset of the data records from the data table that satisfy a respective access policy. For example, a first data table view may be configured to access a first subset of data records associated with timestamps that are within a first time window associated with the respective access policy. The first data table view may be accessed using a first schema with a schema name that is associated with the first time window.

At 420, the computing device 402 may receive, from a user 401, a query to access the data table. For example, the user 401 may provide the request via a client application associated with an access permission. In some examples, the user 401 may indicate a data use category for the query, where the data use category corresponds to the access permission. At 425, in some examples, the computing device 402 may assign the access permission to the user 401 (e.g., or to the client application).

At 430, the computing device 402 may rewrite the query (e.g., after assigning the access permission). For example, the computing device 402 may rewrite the query to request access to the schema with a schema name associated with the access permission of the user. As an illustrative example, if the access permission of the user enables the user to access the data records from within one year, the computing device 402 may rewrite the query to request access to the schema with a schema name corresponding to a time window of one year. That is, the computing device 402 may replace a table name of the data table in the query with the generated schema name. At 435, the computing device 402 may provide the user 401 (e.g., via the client application) access to the data table view via the schema based on rewriting the query.

At 440, the computing device 402 may monitor for policy violations associated with accessing the data table. For example, the policy violations may include an access duration exceeding a threshold, violation of regulatory policies, violation of business policies, and the like. At 445, the computing device 402 may identify a policy violation based on the monitoring. At 450, the computing device 402 may revoke access to the schema based on identifying the violation.

At 455, the computing device 402 may display, to the user 401, a request for the user to provide a data use tag associated with a usage category for accessing the subset of the data records. At 460, the computing device 402 may receive the data use tag in response to the request (e.g., via a GUI of the computing device 402 or client application).

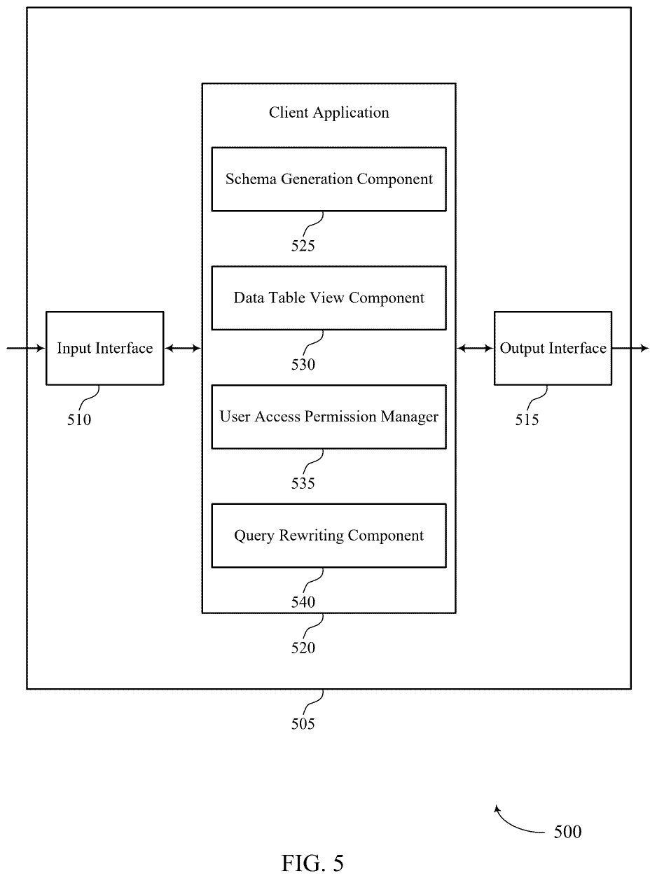

FIG. 5 shows a block diagram 500 of a device 505 that supports automated data access policy enforcement in accordance with aspects of the present disclosure. The device 505 may include an input interface 510, an output interface 515, and a client application 520. The device 505, or one or more components of the device 505 (e.g., the input interface 510, the output interface 515, the client application 520), may include at least one processor, which may be coupled with at least one memory, to support the described techniques. Each of these components may be in communication with one another (e.g., via one or more buses).

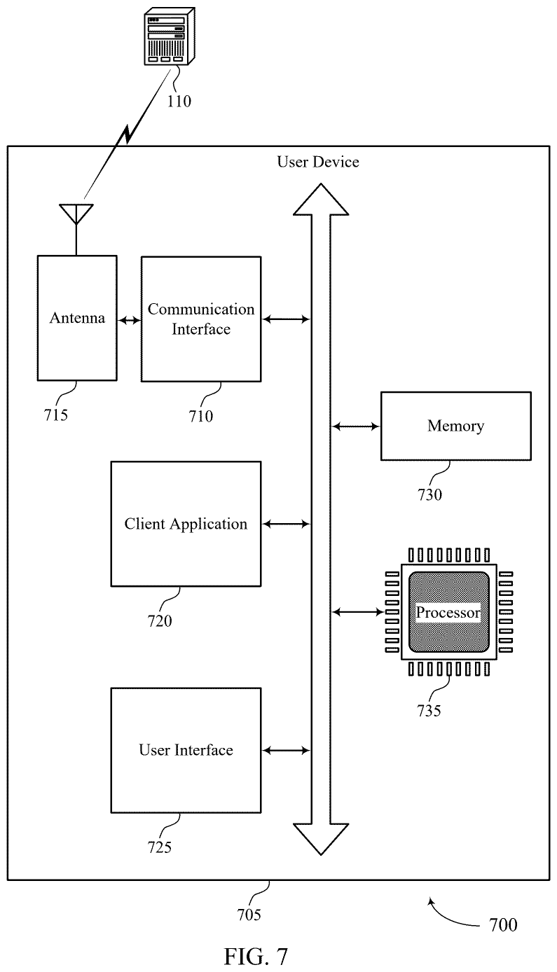

The input interface 510 may manage input signaling for the user device 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the user device 505 for processing. For example, the input interface 510 may transmit such corresponding signaling to the client application 520 to support automated data access policy enforcement. In some cases, the input interface 510 may be a component of a communication interface 710 as described with reference to FIG. 7.

The output interface 515 may manage output signaling for the user device 505. For example, the output interface 515 may receive signaling from other components of the user device 505, such as the client application 520, and may transmit such output signaling corresponding to (e.g., representative of or otherwise based on) such signaling to other systems or devices. In some cases, the output interface 515 may be a component of a communication interface 710 as described with reference to FIG. 7.

For example, the client application 520 may include a schema generation component 525, a data table view component 530, a user access permission manager 535, a query rewriting component 540, or any combination thereof. In some examples, the client application 520, or various components thereof, may be configured to perform various operations (e.g., receiving, monitoring, transmitting) using or otherwise in cooperation with the input interface 510, the output interface 515, or both. For example, the client application 520 may receive information from the input interface 510, send information to the output interface 515, or be integrated in combination with the input interface 510, the output interface 515, or both to receive information, transmit information, or perform various other operations as described herein.

The schema generation component 525 may be configured as or otherwise support a means for generating a schema associated with accessing data of a data table in accordance with an access policy, the data table comprising respective timestamps associated with data records of the data table. The data table view component 530 may be configured as or otherwise support a means for generating a data table view of the data table, wherein the data table view is configured to access a subset of the data records of the data table that satisfies the access policy based on the respective timestamps of the data records of the data table, wherein the data table view is accessed using the schema. The user access permission manager 535 may be configured as or otherwise support a means for identifying a client application that is associated with an access permission that corresponds to the access policy, wherein the client application comprises one or more queries targeted to the data table. The query rewriting component 540 may be configured as or otherwise support a means for rewriting the one or more queries to target the schema of the data table view instead of the data table such that the client application satisfies the access policy.

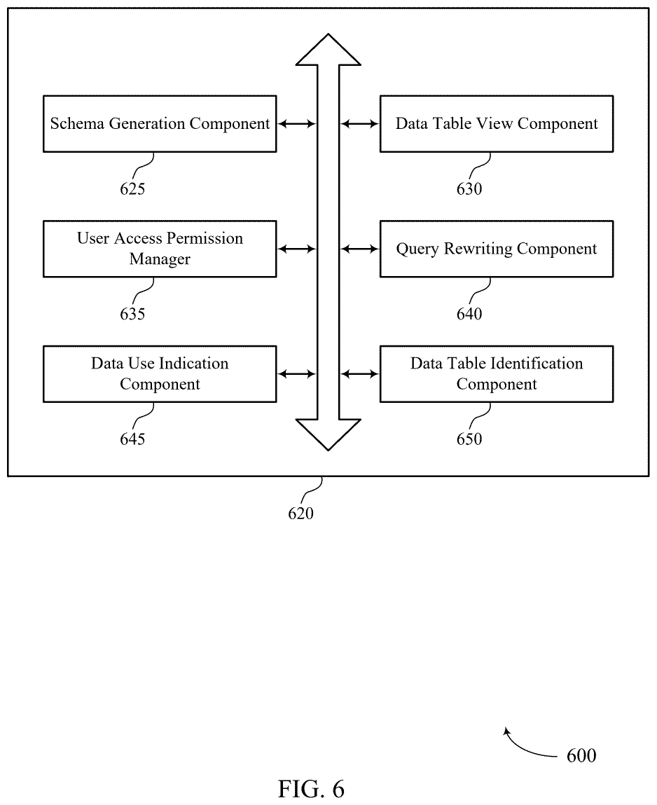

FIG. 6 shows a block diagram 600 of a client application 620 that supports automated data access policy enforcement in accordance with aspects of the present disclosure. The client application 620 may be an example of aspects of a client application or a client application 520, or both, as described herein. The client application 620, or various components thereof, may be an example of means for performing (e.g., to cause the client application 620 to perform) various aspects of automated data access policy enforcement as described herein. For example, the client application 620 may include a schema generation component 625, a data table view component 630, a user access permission manager 635, a query rewriting component 640, a data use indication component 645, a data table identification component 650, or any combination thereof. Each of these components, or components of subcomponents thereof (e.g., one or more processors, one or more memories), may communicate, directly or indirectly, with one another (e.g., via one or more buses).

The schema generation component 625 may be configured as or otherwise support a means for generating a schema associated with accessing data of a data table in accordance with an access policy, the data table comprising respective timestamps associated with data records of the data table. The data table view component 630 may be configured as or otherwise support a means for generating a data table view of the data table, wherein the data table view is configured to access a subset of the data records of the data table that satisfies the access policy based on the respective timestamps of the data records of the data table, wherein the data table view is accessed using the schema. The user access permission manager 635 may be configured as or otherwise support a means for identifying a client application that is associated with an access permission that corresponds to the access policy, wherein the client application comprises one or more queries targeted to the data table. The query rewriting component 640 may be configured as or otherwise support a means for rewriting the one or more queries to target the schema of the data table view instead of the data table such that the client application satisfies the access policy.

In some examples, the subset of the data records are associated with a subset of the respective timestamps. In some examples, the subset of the respective timestamps are within a first time window in accordance with the access policy.

In some examples, the schema generation component 625 may be configured as or otherwise support a means for generating a schema name of the schema using a table name of the data table and an indication of the first time window.

In some examples, to support rewriting a query of the one or more queries, the query rewriting component 640 may be configured as or otherwise support a means for replacing a table name of the data table in the query with the generated schema name.

In some examples, the schema name comprises the table name appended with the indication of the first time window.

In some examples, the user access permission manager 635 may be configured as or otherwise support a means for monitoring access to the data table view or the data table to identify one or more violations of the access policy.

In some examples, the one or more violations of the access policy comprise an access duration exceeding a threshold, violation of one or more regulatory policies, violation of one or more business policies, or any combination thereof.

In some examples, the user access permission manager 635 may be configured as or otherwise support a means for identifying, based at least in part on the monitoring, the one or more violations. In some examples, the user access permission manager 635 may be configured as or otherwise support a means for revoking access to the data table view in accordance with the identifying.

In some examples, the data use indication component 645 may be configured as or otherwise support a means for receiving, via a data access system, a user input comprising an indication of a data use category for the client application, wherein the data use category is one of a plurality of available data use categories. In some examples, the user access permission manager 635 may be configured as or otherwise support a means for assigning, to the client application, the access permission that corresponds to the access policy, wherein the one or more queries are rewritten after assigning the access permission.

In some examples, the data use indication component 645 may be configured as or otherwise support a means for displaying, to a user, a request to provide a data use tag associated with a usage category for accessing the subset of the data records. In some examples, the data use indication component 645 may be configured as or otherwise support a means for receiving a user input comprising an indication of the data use tag in response to the request.

In some examples, the schema generation component 625 may be configured as or otherwise support a means for generating a second schema associated with accessing the data of the data table in accordance with a second access policy. In some examples, the data table view component 630 may be configured as or otherwise support a means for generating a second data table view of the data table, wherein the second data table view is configured to access a second subset of the data records of the data table that satisfies the second access policy based on the respective timestamps of the data records of the data table being within a second time window, wherein the second data table view is accessed using the second schema.

In some examples, the data table identification component 650 may be configured as or otherwise support a means for identifying, from a database, a plurality of data tables including the data table, wherein the plurality of data tables are fact tables.

FIG. 7 shows a diagram of a system 700 including a device 705 that supports automated data access policy enforcement in accordance with aspects of the present disclosure. The device 705 may be an example of or include components of a device 505 as described herein. The device 705 may include components for bi-directional voice and data communications including components for transmitting and receiving communications, such as a client application 720, a communication interface 710, one or more antennas 715, a user interface 725, at least one memory 730, and at least one processor 735. Each of these components may be in communication with one another (e.g., via one or more buses).

The communication interface 710 may manage input and output signals for the device 705 via the antenna 715. For example, the communication interface 710 may enable the user device 705 to exchange information (e.g., input information, output information, or both) with other systems or devices, such as custodial token platform 110 (e.g., supported by one or more servers), via one or more wired or wireless communication links. The communication interface 710 may also utilize or interact with antenna 715 to support communication with other systems or devices. In some cases, the communication interface 710 may represent a physical connection or port to an external peripheral, such as a hardware wallet device. In some cases, the communication interface 710 may utilize an operating system such as iOS®, ANDROID®, MS-DOS®, MS-WINDOWS®, OS/2®, UNIX®, LINUX®, or another known operating system. The communication interface 710 may be implemented as part of the processor 735.

In some cases, the device 705 may include a single antenna 715. However, in some other cases, the device 705 may have more than one antenna 715, which may be capable of concurrently transmitting or receiving multiple wireless transmissions. The communication interface 710 may communicate bi-directionally, via the one or more antennas 715, wired, or wireless links as described herein. For example, the communication interface 710 may represent a wireless transceiver and may communicate bi-directionally with another wireless transceiver. The communication interface 710 may also include a modem to modulate the packets, to provide the modulated packets to one or more antennas 715 for transmission, and to demodulate packets received from the one or more antennas 715.

The user interface 725 may represent a keyboard, a mouse, a touchscreen, a microphone, or a similar device or component. In some cases, a user may interact with the user interface 725. In other cases, the user interface 725 may operate automatically without user interaction. The user interface 725 may display or output information such as information received from other systems or devices or information to be transmitted to other systems or devices.

The memory 730 may include RAM and ROM. The memory 730 may store computer-readable, computer-executable software including instructions that, when executed, cause at least one processor 735 to perform various functions described herein. In some cases, the memory 730 may contain, among other things, a BIOS which may control basic hardware or software operation such as the interaction with peripheral components or devices. The memory 730 may be an example of a single memory or multiple memories. For example, the user device 705 may include one or more memories 730.

The processor 735 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 735 may be configured to operate a memory array using a memory controller. In other cases, a memory controller may be integrated into the processor 735. The processor 735 may be configured to execute computer-readable instructions stored in at least one memory 730 to perform various functions (e.g., functions or tasks supporting a method and system for automated data access policy enforcement). Though a single processor 735 is depicted in the example of FIG. 7, it is to be understood that the user device 705 may include any quantity of one or more of processors 735 and that a group of processors 735 may collectively perform one or more functions ascribed herein to a processor, such as the processor 735. The processor 735 may be an example of a single processor or multiple processors. For example, the device 705 may include one or more processors 735.

For example, the client application 720 may be configured as or otherwise support a means for generating a schema associated with accessing data of a data table in accordance with an access policy, the data table comprising respective timestamps associated with data records of the data table. The client application 720 may be configured as or otherwise support a means for generating a data table view of the data table, wherein the data table view is configured to access a subset of the data records of the data table that satisfies the access policy based on the respective timestamps of the data records of the data table, wherein the data table view is accessed using the schema. The client application 720 may be configured as or otherwise support a means for identifying a client application that is associated with an access permission that corresponds to the access policy, wherein the client application comprises one or more queries targeted to the data table. The client application 720 may be configured as or otherwise support a means for rewriting the one or more queries to target the schema of the data table view instead of the data table such that the client application satisfies the access policy.

By including or configuring the client application 720 in accordance with examples as described herein, the device 705 may support techniques for automated data access policy enforcement, which may result in improved coordination between devices, improved user experience, and improved security.

The client application 720 may include an application (e.g., “app”), program, software, extension, or other component which is configured to facilitate communications with a custodial token platform 110 on a server, one or more nodes of a blockchain network 105, other user devices 705, and other devices or systems. For example, the client application 720 may be an application executable on the user device 705, and the client application 720 may be configured to receive data from a custodial token platform 110, transmit data to the custodial token platform 110, process such data, and cause presentation of such data to a user via a user interface 725. The client application 720 may be an example of a wallet application, a wallet device, or both, and may be associated with a wallet address and may access or use a private key to sign messages to facilitate transfer of crypto tokens, messages, transactions, or the like via a blockchain distributed data store.

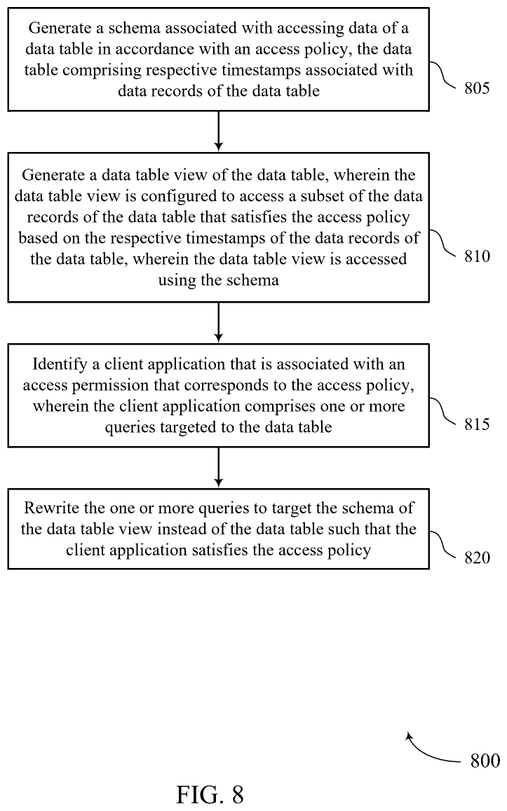

FIG. 8 shows a flowchart illustrating a method 800 that supports automated data access policy enforcement in accordance with aspects of the present disclosure. The operations of the method 800 may be implemented by a user device or its components as described herein. For example, the operations of the method 800 may be performed by a user device as described with reference to FIGS. 1 through 7. In some examples, a user device may execute a set of instructions to control the functional elements of the user device to perform the described functions. Additionally, or alternatively, the user device may perform aspects of the described functions using special-purpose hardware.

At 805, the method may include generating a schema associated with accessing data of a data table in accordance with an access policy, the data table comprising respective timestamps associated with data records of the data table. The operations of 805 may be performed in accordance with examples as disclosed herein. In some examples, aspects of the operations of 805 may be performed by a schema generation component 625.

At 810, the method may include generating a data table view of the data table, wherein the data table view is configured to access a subset of the data records of the data table that satisfies the access policy based on the respective timestamps of the data records of the data table, wherein the data table view is accessed using the schema. The operations of 810 may be performed in accordance with examples as disclosed herein. In some examples, aspects of the operations of 810 may be performed by a data table view component 630.

At 815, the method may include identifying a client application that is associated with an access permission that corresponds to the access policy, wherein the client application comprises one or more queries targeted to the data table. The operations of 815 may be performed in accordance with examples as disclosed herein. In some examples, aspects of the operations of 815 may be performed by a user access permission manager 635.

At 820, the method may include rewriting the one or more queries to target the schema of the data table view instead of the data table such that the client application satisfies the access policy. The operations of 820 may be performed in accordance with examples as disclosed herein. In some examples, aspects of the operations of 820 may be performed by a query rewriting component 640.

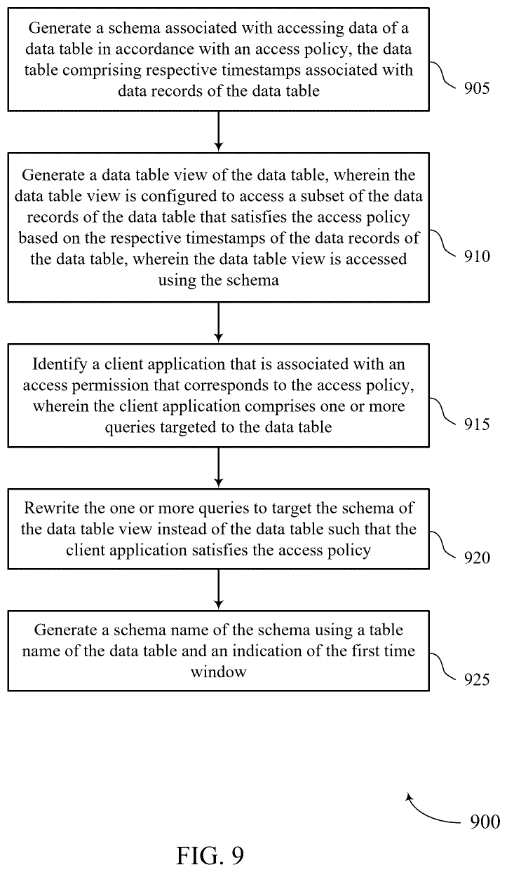

FIG. 9 shows a flowchart illustrating a method 900 that supports automated data access policy enforcement in accordance with aspects of the present disclosure. The operations of the method 900 may be implemented by a user device or its components as described herein. For example, the operations of the method 900 may be performed by a user device as described with reference to FIGS. 1 through 7. In some examples, a user device may execute a set of instructions to control the functional elements of the user device to perform the described functions. Additionally, or alternatively, the user device may perform aspects of the described functions using special-purpose hardware.

At 905, the method may include generating a schema associated with accessing data of a data table in accordance with an access policy, the data table comprising respective timestamps associated with data records of the data table. The operations of 905 may be performed in accordance with examples as disclosed herein. In some examples, aspects of the operations of 905 may be performed by a schema generation component 625.

At 910, the method may include generating a data table view of the data table, wherein the data table view is configured to access a subset of the data records of the data table that satisfies the access policy based on the respective timestamps of the data records of the data table, wherein the data table view is accessed using the schema. The operations of 910 may be performed in accordance with examples as disclosed herein. In some examples, aspects of the operations of 910 may be performed by a data table view component 630.

At 915, the method may include identifying a client application that is associated with an access permission that corresponds to the access policy, wherein the client application comprises one or more queries targeted to the data table. The operations of 915 may be performed in accordance with examples as disclosed herein. In some examples, aspects of the operations of 915 may be performed by a user access permission manager 635.

At 920, the method may include rewriting the one or more queries to target the schema of the data table view instead of the data table such that the client application satisfies the access policy. The operations of 920 may be performed in accordance with examples as disclosed herein. In some examples, aspects of the operations of 920 may be performed by a query rewriting component 640.

At 925, the method may include generating a schema name of the schema using a table name of the data table and an indication of the first time window. The operations of 925 may be performed in accordance with examples as disclosed herein. In some examples, aspects of the operations of 925 may be performed by a schema generation component 625.

A method by an apparatus is described. The method may include generating a schema associated with accessing data of a data table in accordance with an access policy, the data table comprising respective timestamps associated with data records of the data table, generating a data table view of the data table, wherein the data table view is configured to access a subset of the data records of the data table that satisfies the access policy based on the respective timestamps of the data records of the data table, wherein the data table view is accessed using the schema, identifying a client application that is associated with an access permission that corresponds to the access policy, wherein the client application comprises one or more queries targeted to the data table, and rewriting the one or more queries to target the schema of the data table view instead of the data table such that the client application satisfies the access policy.

An apparatus is described. The apparatus may include one or more memories storing processor executable code, and one or more processors coupled with the one or more memories. The one or more processors may individually or collectively be operable to execute the code to cause the apparatus to generate a schema associated with accessing data of a data table in accordance with an access policy, the data table comprising respective timestamps associated with data records of the data table, generate a data table view of the data table, wherein the data table view is configured to access a subset of the data records of the data table that satisfies the access policy based on the respective timestamps of the data records of the data table, wherein the data table view is accessed using the schema, identify a client application that is associated with an access permission that corresponds to the access policy, wherein the client application comprises one or more queries targeted to the data table, and rewrite the one or more queries to target the schema of the data table view instead of the data table such that the client application satisfies the access policy.

Another apparatus is described. The apparatus may include means for generating a schema associated with accessing data of a data table in accordance with an access policy, the data table comprising respective timestamps associated with data records of the data table, means for generating a data table view of the data table, wherein the data table view is configured to access a subset of the data records of the data table that satisfies the access policy based on the respective timestamps of the data records of the data table, wherein the data table view is accessed using the schema, means for identifying a client application that is associated with an access permission that corresponds to the access policy, wherein the client application comprises one or more queries targeted to the data table, and means for rewriting the one or more queries to target the schema of the data table view instead of the data table such that the client application satisfies the access policy.

A non-transitory computer-readable medium storing code is described. The code may include instructions executable by one or more processors to generate a schema associated with accessing data of a data table in accordance with an access policy, the data table comprising respective timestamps associated with data records of the data table, generate a data table view of the data table, wherein the data table view is configured to access a subset of the data records of the data table that satisfies the access policy based on the respective timestamps of the data records of the data table, wherein the data table view is accessed using the schema, identify a client application that is associated with an access permission that corresponds to the access policy, wherein the client application comprises one or more queries targeted to the data table, and rewrite the one or more queries to target the schema of the data table view instead of the data table such that the client application satisfies the access policy.

In some examples of the method, apparatus, and non-transitory computer-readable medium described herein, the subset of the data records may be associated with a subset of the respective timestamps and the subset of the respective timestamps may be within a first time window in accordance with the access policy.

Some examples of the method, apparatus, and non-transitory computer-readable medium described herein may further include operations, features, means, or instructions for generating a schema name of the schema using a table name of the data table and an indication of the first time window.

In some examples of the method, apparatus, and non-transitory computer-readable medium described herein, rewriting a query of the one or more queries may include operations, features, means, or instructions for replacing a table name of the data table in the query with the generated schema name.

In some examples of the method, apparatus, and non-transitory computer-readable medium described herein, the schema name comprises the table name appended with the indication of the first time window.

Some examples of the method, apparatus, and non-transitory computer-readable medium described herein may further include operations, features, means, or instructions for monitoring access to the data table view or the data table to identify one or more violations of the access policy.

In some examples of the method, apparatus, and non-transitory computer-readable medium described herein, the one or more violations of the access policy comprise an access duration exceeding a threshold, violation of one or more regulatory policies, violation of one or more business policies, or any combination thereof.

Some examples of the method, apparatus, and non-transitory computer-readable medium described herein may further include operations, features, means, or instructions for identifying, based at least in part on the monitoring, the one or more violations and revoking access to the data table view in accordance with the identifying.

Some examples of the method, apparatus, and non-transitory computer-readable medium described herein may further include operations, features, means, or instructions for receiving, via a data access system, a user input comprising an indication of a data use category for the client application, wherein the data use category may be one of a plurality of available data use categories and assigning, to the client application, the access permission that corresponds to the access policy, wherein the one or more queries may be rewritten after assigning the access permission.

Some examples of the method, apparatus, and non-transitory computer-readable medium described herein may further include operations, features, means, or instructions for displaying, to a user, a request to provide a data use tag associated with a usage category for accessing the subset of the data records and receiving a user input comprising an indication of the data use tag in response to the request.

Some examples of the method, apparatus, and non-transitory computer-readable medium described herein may further include operations, features, means, or instructions for generating a second schema associated with accessing the data of the data table in accordance with a second access policy and generating a second data table view of the data table, wherein the second data table view may be configured to access a second subset of the data records of the data table that satisfies the second access policy based on the respective timestamps of the data records of the data table being within a second time window, wherein the second data table view may be accessed using the second schema.

Some examples of the method, apparatus, and non-transitory computer-readable medium described herein may further include operations, features, means, or instructions for identifying, from a database, a plurality of data tables including the data table, wherein the plurality of data tables may be fact tables.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
generating a schema associated with accessing data of a data table in accordance with an access policy, the data table comprising respective timestamps associated with data records of the data table;
generating a data table view of the data table, wherein the data table view is configured to access a subset of the data records of the data table that satisfies the access policy based on the respective timestamps of the data records of the data table, wherein the data table view is accessed using the schema;
identifying a client application that is associated with an access permission that corresponds to the access policy, wherein the client application comprises one or more queries targeted to the data table; and
rewriting the one or more queries to target the schema of the data table view instead of the data table such that the client application satisfies the access policy.

2. The method of claim 1, wherein the subset of the data records are associated with a subset of the respective timestamps, and wherein the subset of the respective timestamps are within a first time window in accordance with the access policy.

3. The method of claim 2, further comprising:
generating a schema name of the schema using a table name of the data table and an indication of the first time window.

4. The method of claim 3, wherein rewriting a query of the one or more queries further comprises:
replacing a table name of the data table in the query with the generated schema name.

5. The method of claim 3, wherein the schema name comprises the table name appended with the indication of the first time window.

6. The method of claim 1, further comprising:
monitoring access to the data table view or the data table to identify one or more violations of the access policy.

7. The method of claim 6, wherein the one or more violations of the access policy comprise an access duration exceeding a threshold, violation of one or more regulatory policies, violation of one or more business policies, or any combination thereof.

8. The method of claim 6, further comprising:
identifying, based at least in part on the monitoring, the one or more violations; and
revoking access to the data table view in accordance with the identifying.

9. The method of claim 1, further comprising:
receiving, via a data access system, a user input comprising an indication of a data use category for the client application, wherein the data use category is one of a plurality of available data use categories; and
assigning, to the client application, the access permission that corresponds to the access policy, wherein the one or more queries are rewritten after assigning the access permission.

10. The method of claim 1, further comprising:
displaying, to a user, a request to provide a data use tag associated with a usage category for accessing the subset of the data records; and
receiving a user input comprising an indication of the data use tag in response to the request.

11. The method of claim 1, further comprising:
generating a second schema associated with accessing the data of the data table in accordance with a second access policy; and
generating a second data table view of the data table, wherein the second data table view is configured to access a second subset of the data records of the data table that satisfies the second access policy based on the respective timestamps of the data records of the data table being within a second time window, wherein the second data table view is accessed using the second schema.

12. The method of claim 1, further comprising:
identifying, from a database, a plurality of data tables including the data table, wherein the plurality of data tables are fact tables.

13. An apparatus, comprising:
one or more memories storing processor-executable code; and
one or more processors coupled with the one or more memories individually or collectively operable to execute the code to cause the apparatus to:
generate a schema associated with accessing data records of a data table in accordance with an access policy;
generate a data table view of the data table, wherein the data table view is configured to access a subset of the data records of the data table that satisfies the access policy, wherein the data table view is accessed using the schema;
identify a client application that is associated with an access permission that corresponds to the access policy, wherein the client application comprises one or more queries targeted to the data table; and
rewrite the one or more queries to target the schema of the data table view instead of the data table such that the client application satisfies the access policy.

14. The apparatus of claim 13, wherein the data table comprises respective timestamps associated with data records of the data table, and wherein generating the data table view is based at least in part on the respective timestamps.

15. The apparatus of claim 14, wherein the subset of the data records are associated with a subset of the respective timestamps, and wherein the subset of the respective timestamps are within a first time window in accordance with the access policy.

16. The apparatus of claim 15, wherein the one or more processors are individually or collectively further operable to cause the apparatus to:
generate a schema name of the schema using a table name of the data table and an indication of the first time window.

17. The apparatus of claim 16, wherein, to rewrite a query of the one or more queries, the one or more processors are individually or collectively further operable to cause the apparatus to:
replace a table name of the data table in the query with the generated schema name.

18. The apparatus of claim 16, wherein the schema name comprises the table name appended with the indication of the first time window.

19. The apparatus of claim 13, wherein the one or more processors are individually or collectively further operable to cause the apparatus to:
monitor access to the data table view or the data table to identify one or more violations of the access policy.

20. A non-transitory computer-readable medium storing code, the code comprising instructions executable by one or more processors to:
identify, from a database, a data table comprising respective timestamps associated with data records of the data table;
generate a schema associated with accessing data of the data table in accordance with an access policy;
generate a data table view of the data table, wherein the data table view is configured to access a subset of the data records of the data table that satisfies the access policy based on the respective timestamps of the data records of the data table, wherein the data table view is accessed using the schema;
identify a client application that is associated with an access permission that corresponds to the access policy, wherein the client application comprises one or more queries targeted to the data table; and
rewrite the one or more queries to target the schema of the data table view instead of the data table such that the client application satisfies the access policy.
